(19) United States
(12) Patent Application Publication
(10) Pub. No.: US 2024/0352981 A1
(43) Pub. Date: Oct. 24, 2024

(54) HYDRAULIC ASSEMBLY, FRICTION CLUTCH AND METHOD FOR OPERATING A FRICTION CLUTCH

(71) Applicant: Schaeffler Technologies AG & Co. KG, Herzogenaurach (DE)

(72) Inventor: Marco GRETHEL, Bühlertal (DE)

(73) Assignee: Schaeffler Technologies AG & Co. KG, Herzogenaurach (DE)

(21) Appl. No.: 18/681,666

(22) PCT Filed: Jul. 13, 2022
(86) PCT No.: PCT/DE2022/100500

§ 371 Date: Jul. 11, 2024

(30) Foreign Application Priority Data
Aug. 10, 2021 (DE) 10 2021 120 716.9

(51) Int. Cl. F16D 48/02

(52) U.S. Cl. CPC F16D 48/0206; F16D 2048/0248; F16D 2048/0254; F16D 2048/0266; F16D 2048/029

(57) ABSTRACT

The invention relates to a hydraulic assembly for driving a friction clutch, comprising a hydraulically driveable actuator cylinder, a pump driving the actuator cylinder, wherein the actuator cylinder has a working piston with a working chamber and the working piston moveably arranged in the working chamber divides said working chamber into a main chamber and an auxiliary chamber, at least one control valve which is designed as a multi-port valve and arranged in the line path between the actuator cylinder and the pump, wherein a first supply line leads from the pump to the control valve, whereby a line path is created via a second supply line in a first valve position of the control valve, which leads to the main chamber of the actuator cylinder. In addition, in a second valve position of the control valve, the auxiliary chamber of the working chamber can be fluidically connected to the line path of the first and second supply lines via a first discharge line, while simultaneously, in the second valve position, the main chamber is connected via the first and second supply lines by means of the pump.

The invention relates to a hydraulic assembly according to the preamble of claim 1, a friction clutch according to the preamble of claim 8 and a method for operating a friction clutch according to claim 9.

Such friction clutches are known in the prior art. A torque transmission unit with a friction clutch and a hydraulic actuation system is known, for example, from DE 10 2011 108649 A1, which comprises a stepped piston unit with a stepped piston which has a first piston section which can be moved in a first pressure chamber and which has a first, smaller hydraulically effective area and a second piston section which can be moved in a second pressure chamber and which has a second, larger hydraulically effective area. Here, the first and second pressure chambers are fluidically connected by means of an overflow line, according to a position of the first piston section. According to DE 10 2011 108649 A1, an actuating piston interacts with the friction clutch to selectively actuate the torque transmission unit.

Furthermore, DE 10 2015 20 4673 B3 discloses a hydraulic assembly for a friction clutch, which comprises a switching unit having an input, a closable first output and a closable second output. The switching unit is fluidically connected to the volume flow source via the input by means of the hydraulic supply line, with the lower input pressure being converted into a higher output pressure by means of a pressure intensifier.

However, the aforementioned solutions do not constitute an optimal solution as regards the fast passing of the initially contactless approach phase with very low force up to the bite point and the subsequent contact and force transmission phase with high force application.

The object is therefore to provide a hydraulic assembly for a friction clutch that enables an improved process of these two phases.

For this purpose, the invention comprises a hydraulic assembly according to the features of claim 1, a friction clutch according to the features of claim 8 and a method according to claim 9. Advantageous embodiments are set out in the dependent claims.

The hydraulic assembly according to the invention for driving a friction clutch, comprising a hydraulically drivable actuator cylinder, a pump driving at least the actuator cylinder, wherein the actuator cylinder comprises a working piston with a working chamber, wherein the working piston arranged movably in the working chamber, in particular linearly movably, divides this working chamber into a main chamber and an auxiliary chamber.

In the present case, “friction clutch” should not be understood as limiting. Rather, a “friction clutch” should quite generally be understood to mean a torque transmission device in the form of a frictional and/or interlocking clutch or brake.

Furthermore, at least one control valve is included, which is designed as a multi-port valve and is arranged in the line path between the actuator cylinder and the pump, wherein a first supply line leads from the pump to the control valve and a line path is created via a second supply line in a first valve position. The second supply line leads from the control valve to the main chamber of the actuator cylinder. In a second valve position of the control valve, the auxiliary chamber of the working chamber can be fluidically connected to the line path of the first and second supply lines via a first discharge line, while simultaneously, in the second valve position, the main chamber is connected via the first and second supply lines by means of the pump.

The supply from the first auxiliary chamber into the supply line path and via this into the main chamber, as caused by the second valve position of the control valve, can in one embodiment either take place within the control valve itself or, in an alternative embodiment, via at least one branch line which leads into the first and/or second supply line.

The advantage here is that during the piston movement during the approach phase, also called the air travel region, the smaller volume of the actuator cylinder, which is designed as a differential area piston, is used as a further volume source of the hydraulic fluid for applying the larger volume (main chamber). After reaching the bite point (TP), only the large area or the associated main chamber is supplied by the driving pump, i.e. the first volume flow source, and the smaller volume (auxiliary chamber) is connected to the tank or reservoir of the hydraulic fluid.

In an improved embodiment, in the first valve position of the control valve, only
the (supply) line path is connected to the first and second supply lines to the main chamber of the actuator cylinder and
the (discharge) line path is connected to the first and second discharge lines from the auxiliary chamber to the tank. In this first valve position, there is a rapid increase in pressure with an active delivery unit that delivers into the (supply) line path. “Conveyor unit” and “pump” are used synonymously herein unless stated otherwise. Overall, it applies to all embodiments described here that the pump can be operated alternately with regard to the pressure and suction side, so, unless expressly described to the contrary, both operating modes are possible or a state of the hydraulic assembly and in particular of the actuator cylinder can be reversed and canceled by changing from pressure mode to suction mode of the pump.

In the second valve position, hydraulic fluid is displaced from the auxiliary chamber by moving the working piston in the direction of the friction clutch and at least partially introduced into the supply line path coming from the pump, or thereby directed into the main chamber of the actuator cylinder and not or only partially into the discharge line path, in particular the discharge line path leading to the tank.

According to a further improvement, the auxiliary chamber can be completely fluidically connected to the line path of the first and second supply lines via a first discharge line in the second valve position of the control valve, while the second discharge line leading to the tank is completely blocked.

In a further embodiment, the auxiliary chamber is smaller than the working chamber, preferably the auxiliary chamber is at least 10% smaller, in particular more than 20% smaller than the main chamber.

Advantageously, the control valve is a passive multi-port valve which switches from one valve position to the other valve position when a defined fluid pressure is reached in one of the two supply lines, in particular in the first supply line. In an alternative embodiment, the control valve is an electrically switchable solenoid valve.

In a further advantageous embodiment, a movement sensor is arranged on or at the working piston of the actuator cylinder and the movement sensor information is used to control the control valve. A further improvement consists in that the hydraulic assembly is monitored by evaluating the fluid pressure in the first and/or the second supply line and the data from the movement sensor on the working piston. Here, TARGET values/ranges are compared with ACTUAL values/ranges and control and/or warning information is derived for the vehicle or the operator.

According to a further embodiment and/or improvement, at least one pressure sensor is provided in one of the lines or line sections so that the bite point can be identified and/or determined via a pressure measurement. This determination is made by identifying a pressure gradient and/or an absolute pressure in a line.

In a further embodiment, a coolant and lubricant line branches off from the first supply line and upstream of the control valve, wherein a (fluid) orifice is arranged in the coolant and lubricant line, through which only a very small fluid flow is conducted. An improvement consists in that the free end of the coolant and lubricant line has a diffuser, which is arranged adjacent to a free end of the working piston of the actuator cylinder and is directed in particular towards the friction clutch to be engaged and disengaged. The diffuser can in particular be a slit nozzle or a series of individual nozzles.

In a further embodiment, a tank is arranged upstream of the pump, which is used as a hydraulic reservoir and which is connected to the pump via a supply line. The pump is advantageously a double-acting pump which can operate both in a pushing and a suction manner on the first supply line.

The invention also comprises a friction clutch having an axis of rotation for releasably connecting an output shaft to a consumer, which comprises or has the following
at least one friction pack with at least one pressure plate and at least one corresponding friction disk, via which torque can be transmitted in the pressed state; and a hydraulic assembly which is designed according to any one of the variants described above, and wherein the actuator cylinder is configured to press on the at least one friction pack. The consumer can also be a brake or act as a brake.

Furthermore, the invention comprises a method for operating a friction clutch, wherein a pressure plate of the actuator cylinder is moved by means of an actuator cylinder and a friction disk on the consumer side is moved by means of a movable working piston. In this case, the working piston is guided in a working chamber which comprises at least one auxiliary chamber and a main chamber. The friction clutch is advanced and engaged in at least two steps. In the first step, the working piston is moved faster by means of a drive unit, in particular a pump, than in the second step, with the same power of the drive unit (pump). In the first step, the fluid (hydraulic fluid) is at least partially guided from an auxiliary chamber of the actuator cylinder into a driving main chamber of the actuator cylinder. The supply from the auxiliary chamber into the main chamber of the actuator cylinder takes place in addition to the main supply of fluid via a supply line path, coming from the pump, to the main chamber.

A hydraulic assembly according to any one of the aforementioned embodiments is advantageously used here.

The invention is described below by way of example with reference to the drawings. In the drawings:

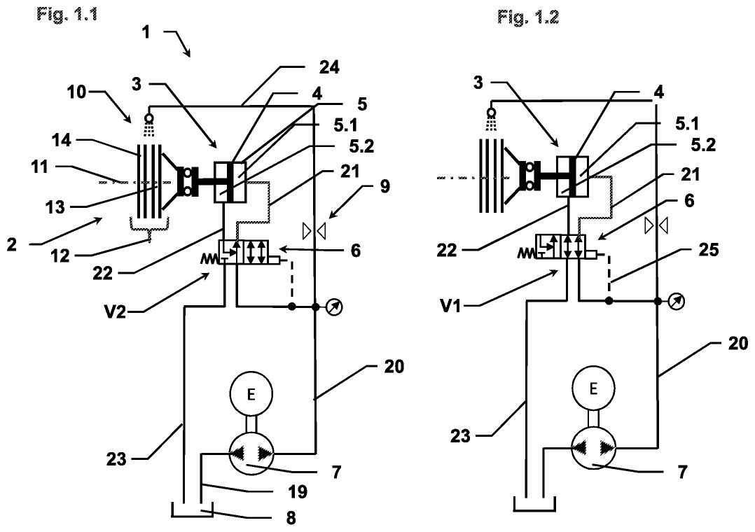

FIGS. 1.1 and 1.2 show an embodiment of the hydraulic assembly as a flow diagram in two valve positions;

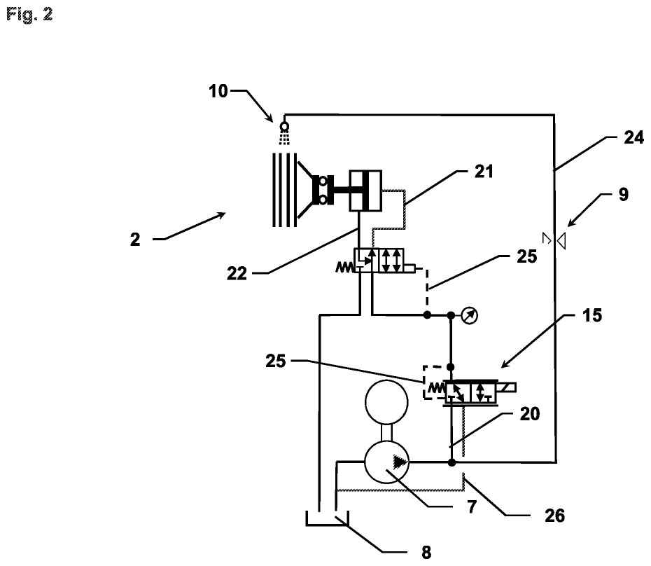

FIG. 2 shows an improved embodiment compared to FIGS. 1.1 and 1.2 as a flow diagram;

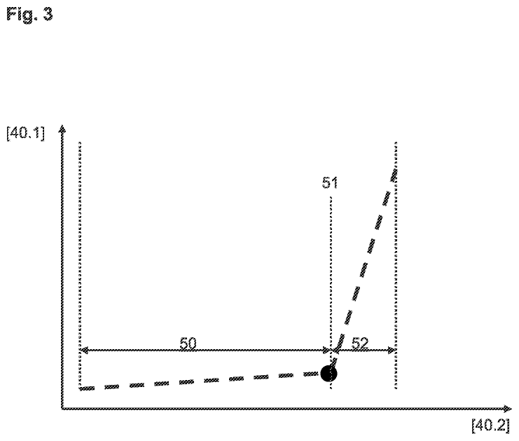

FIG. 3 shows a schematic course of a clutch characteristic curve of a friction clutch.

In FIGS. 1.1 and 1.2, the hydraulic assembly 1 is shown in two valve positions V1, V2. The friction clutch 2 is driven by the actuator cylinder 3. The actuator cylinder 3 has a working piston 4, which is mounted in a working chamber 5 and moves linearly. The working piston 4 transforms the working chamber 5 into a main chamber 5.1 and an auxiliary chamber 5.2. The supply line path from the pump 7 to the main chamber 5.1 is divided into two—into a first supply line 20 from the pump to a control valve 6, which is designed as a 4/4 multi-port valve, and into a second supply line 21, which leads from the control valve 6 to the main chamber. The discharge line path is also divided into two—into a first discharge line 22 from the auxiliary chamber 5.2 to the control valve 6 and a second drainage line 23, from the control valve 6 downwards to a tank 8, which serves as a reservoir for the hydraulic fluid. The pump 6 is also connected to the tank 8 via the suction line 19. Furthermore, a coolant and lubricant line 24, in which an orifice 9 is provided, leads to a diffuser 10, which is arranged opposite the friction clutch 2 and lubricates and cools the friction pack 12.

In the initial position, with the friction pack 12 disengaged, the control valve 6 is preloaded and held in the valve position V2 by the spring 6.1, as shown in FIG. 1.1. The pump 7 feeds into the first supply line 20 and via the control valve 6 into the second supply line 21 into the main chamber 5.1, such that the working piston 4 is moved to the left and the auxiliary chamber 5.2 is reduced in size. The displaced hydraulic fluid is directed into the supply line path in the control valve 6 and thus into the main chamber 5.1 so that the working piston 4 advances quickly. The friction pack comes into contact so that the advancement largely ends and the switching point is reached. The control valve 6 switches to the first valve position V1 from a defined pressure or pressure increase in the main supply line 20, which is transmitted via the control line 25. This is the valve position for the phase with high contact pressure. For the disengaging the friction pack 12 by the return movement of the working piston 4, the pump 6 is set to suction mode so that it sucks on the first supply line 20 and thus on the entire supply line path, causing the working piston 4 to move to the right and at the same time the auxiliary chamber 5.2 is enlarged and fills with hydraulic fluid from the tank 8.

The embodiment shown in FIG. 2 shows a pump 7, which is designed as a simple, hydraulic supply that only has a suction and a pressure side. Here, the first supply line 20 is directed via a switching valve 15, which is designed, for example, as a pressure-reducing valve. In one variant (not shown), this switching valve 15 is designed as a combined active pressure directional control valve. The orifice 9 for cooling can also be designed as a typical pressure relief valve (not shown). In the position of the switching valve 15 shown as inactive, the hydraulic assembly 1 can be switched via the control valve 6, as shown in FIGS. 1.1 and 1.2. In the valve position of the switching valve 15 shown, the supply line path via the first supply line 20 to the pump 7 is closed. The supply line 20 can passively empty at least partially into the tank 8 with the line portion downstream of the control valve 15, to which tank it is connected via the discharge line 26. In the valve position shown, the pump 7 works exclusively in a pushing manner on the side of the coolant and lubricant line 24 via the orifice 9 to the diffuser 10.

Finally, FIG. 3 shows a greatly simplified clutch characteristic curve. The force or pressure is plotted on the axis (y-axis) labeled 40.1 and the distance or volume is plotted on the axis (x-axis) labeled 40.2. In the approach step 50, a long path is traversed until the bite point 51 is reached, with only a slight increase in force/pressure. In the contact pressure phase 52, the situation is reversed. If the distance/volume progress is small, a high pressure increase occurs.

### LIST OF REFERENCE SIGNS

1 Hydraulic assembly
2 Friction clutch
3 Actuator cylinder
4 Working piston
5 Working chamber
   5.1 Main chamber
   5.2 Auxiliary chamber
6 Control valve
7 Pump
8 Tank
9 Orifice
10 Diffuser
12 Friction pack
11 Pressure disk
12 Friction disk
13 Switching valve
17 Supply line
18 Supply line, first
19 Supply line, second
20 Discharge line, first
21 Discharge line, second
22 Coolant and lubricant line
23 Control line
24 Discharge line
40.1 y-axis
40.2 x-axis
50 Approach step
51 Bite point
52 Contact pressure phase
V1 Valve position, first
V2 Valve position, second

1. A hydraulic assembly (1) for driving a friction clutch (2), comprising a hydraulically drivable actuator cylinder (3), having
a pump (7) driving the actuator cylinder (3),
wherein the actuator cylinder (3) comprises a working piston (4) with a working chamber (5), wherein the working piston (4) movably arranged in the working chamber (5) divides said working chamber (5) into a main chamber (5.1) and an auxiliary chamber (5.2),
at least one control valve (6), which is designed as a multi-port valve and is arranged in the line path between the actuator cylinder (3) and the pump (7), wherein a first supply line (20) leads from the pump (7) to the control valve (6) and a line path is created via a second supply line (21) in a first valve position (V1) of the control valve (6), characterized in that the second supply line (21) leads to the main chamber (5.1) of the actuator cylinder (3) and the auxiliary chamber (5.2) of the working chamber (5) in a second valve position of the control valve (6) can be fluidically connected to the line path of the first and second supply lines (20, 21) via a first discharge line (22), while simultaneously, in the second valve position (V2), the main chamber (5.1) is connected via the first and second supply lines (20, 21) by means of the pump (7).

2. The hydraulic assembly (1) according to claim 1, characterized in that, in the first valve position (V1), only the (supply) line path with the first and second supply lines (20, 21) to the main chamber (5.1) of the actuator cylinder (3) exists and the (discharge) line path with the first and second discharge lines (22, 23) from the auxiliary chamber (5.2) to the tank (8) exists.

3. The hydraulic assembly (1) according to claim 1 or 2, characterized in that the auxiliary chamber (5.2) can be completely fluidically connected to the line path of the first and second supply lines (20, 21) via a first discharge line (21) in the second valve position (V2) of the control valve (6), while the second discharge line (23) leading to the tank (8) is completely blocked.

4. The hydraulic assembly (1) according to any one of the preceding claims, characterized in that the auxiliary chamber (5.2) is smaller than the working chamber (5.1), preferably smaller by at least 10%, in particular smaller by more than 20%.

5. The hydraulic assembly (1) according to any one of the preceding claims, characterized in that the control valve (6) is a passive multi-port valve, in particular a 4/4 multi-port valve, which switches from the first valve position (V1) to the second valve position (V2) when a fluid pressure is reached in one of the two supply lines (20, 21), in particular the control valve (6) is a solenoid valve.

6. The hydraulic assembly (1) according to any one of the preceding claims, characterized in that a coolant and lubricant line (24) branches off from the first supply line (20) and upstream of the control valve (6), wherein an orifice (9) is arranged in the coolant and lubricant line (40).

7. The hydraulic assembly (1) according to any one of the preceding claims, characterized in that the pump (7) is a double-acting pump which can operate both in a pushing and a suction manner on the first supply line (20).

8. A friction clutch (2) having an axis of rotation (11) for releasably connecting an output shaft to a consumer,
having
at least one friction pack (12) with at least one pressure plate (13) and at least one corresponding friction disk (14), via which
torque can be transmitted in the pressed state;
at least one hydraulic assembly (1) according to any one of the preceding claims,
wherein the actuator cylinder (3) is configured to press on the at least one friction pack (25).

9. A method for operating a friction clutch (2), wherein a pressure plate (13) on the side of an actuator cylinder (3) is moved by means of an actuator cylinder (3) and a friction disk (14) on the consumer side is moved by means of a working piston (4) which can be moved into a working chamber (5) comprising at least one auxiliary chamber (5.2) and a main chamber (5.1), characterized in that the drive for engaging the friction clutch takes place in at least two steps, wherein in the first step the working piston (4), with the same drive power of a drive unit, in particular a pump (6), moves faster than in the second step, wherein in the first step the fluid is directed from an auxiliary chamber (5.2) into a main chamber (5.1), in addition to the supply of fluid via a supply line path coming from the pump (6).

10. The method according to claim 9, characterized in that a hydraulic assembly (1) according to any one of claims 1 to 7 is used.
